(19) United States
(12) Patent Application Publication
(10) Pub. No.: US 2026/0253280 A1
(43) Pub. Date: Aug. 27, 2026

(54) AUTOMATED STORYBOARDING USING GENERATIVE AI-BASED SYSTEMS AND APPLICATIONS

(71) Applicant: NVIDIA Corporation, Santa Clara, CA (US)

(72) Inventors: Aditya Karra, Pune (IN); Amruta Lonkar, Munich (DE); Vikas Tomar, Gurugram (IN); Neeraj Kumar, Pune (IN); Ashish Sachdev, Pune (IN); Piyush Sharma, Pune (IN)

(21) Appl. No.: 19/061,506

(22) Filed: Feb. 24, 2025

(51) Int. Cl. G06T 11/60; G06T 13/80

(52) U.S. Cl. CPC G06T 11/60; G06T 13/80

(57) ABSTRACT

In various examples, generative AI-based systems and applications may be used to automatically transform basic storylines into comprehensive storyboards, as well as to automatically generate animatics based on the storyboards. For instance, input data (e.g., text, audio, etc.) representing a storyline may be obtained and analyzed using one or more AI models. The AI model(s) may segment the storyline into a plurality of scenes and generate storyboard frames for one or more of the scenes. In some examples, the AI model(s) may generate or otherwise determine scene descriptions, cinematographic details, and/or visual representations (e.g., images) for each of the scene(s), and this information may be included or otherwise used to generate the storyboard frames corresponding to each of those scene(s). Additionally, in some examples, the AI model(s) may perform extrapolation to generate intermediate scenes/storyboard frames to create animatics.

### BACKGROUND

Storyboarding is a technique that may be used by creators to visually plan and organize the sequence of events in a project, helping creators communicate both the narrative and technical aspects of the project. Storyboards are often used in filmmaking, animation, advertising, game development, and/or other creative fields to serve as a blueprint for production and help provide structured ways to break down ideas into sequential visual frames. By doing so, storyboarding may help teams align on a shared vision, organize workflows, and/or identify potential issues before production begins, thereby ensuring that the final product follows the intended concept and meets project goals.

However, creating effective storyboards may oftentimes be a difficult task that requires a combination of advanced skills, such as the ability to visualize a story in detail, articulate those visuals through drawing, and incorporate technical elements like camera angles and scene transitions. Unfortunately, these skills are not always commonly possessed, making it difficult for individuals without artistic training or technical expertise to create effective storyboards. Furthermore, the process of creating a storyboard may be time intensive as it may frequently demand careful planning, iteration, and refinement. While modern text-to-image solutions may partially address drawing gaps in storyboard creation, these tools may still require users to provide detailed scene descriptions and possess technical knowledge, leaving significant barriers for those unfamiliar with the nuances of storytelling and/or production.

### SUMMARY

Embodiments of the present disclosure relate to automated storyboarding using generative Artificial Intelligence (AI)-based systems and applications. Systems and methods are disclosed that, in various examples, use generative AI techniques to automatically transform basic storylines into comprehensive storyboards, as well as to automatically generate animatics based on the storyboards. For instance, input data (e.g., text, audio, etc.) representing a storyline may be obtained and analyzed using one or more AI models. The AI model(s) may segment the storyline into a plurality of scenes and generate storyboard frames for one or more of the scenes. In some examples, the AI model(s) may automatically generate or otherwise determine scene descriptions, cinematographic details, and/or visual representations (e.g., images) for each of the scene(s), and this information may be included or otherwise used to generate the storyboard frames corresponding to each of the scene(s). Additionally, in some examples, the AI model(s) may perform extrapolation to generate intermediate scenes/storyboard frames as part of creating animatics.

In contrast to conventional systems, the systems and applications of the present disclosure, in some embodiments, may automatically generate detailed storyboards for a storyline based on basic textual (or audio, visual, etc.) inputs. For instance, by using generative AI models to process input data representing a narrative of a story, the systems and applications of the present disclosure may, among other things, segment the narrative into a plurality of scenes and automatically generate scene descriptions, cinematographic details, and/or visual representations for each scene. That is, in contrast to conventional systems, which may simply use text-to-image models to generate storyboard images based on human-supplied text, the systems and applications of the present disclosure provide end-to-end pipelines that automatically transform a narrative/storyline into detailed storyboard frames. As such, the systems and applications of the present disclosure make storyboarding accessible to everyone, regardless of their skill set.

Additionally, in contrast to conventional systems, the systems and applications of the present disclosure may provide users with a variety of storyboards and/or storyboard frames/scenes to choose from based on a single storyline input, thereby allowing the users to explore different creative options. Furthermore, the systems and applications of the present disclosure may review and enhance existing storyboards (e.g., user-created and/or system-created storyboards), as well as offer constructive feedback and/or improvements to ensure the best possible outcome.

### BRIEF DESCRIPTION OF THE DRAWINGS

The present systems and methods for automated storyboarding using generative AI-based systems and applications are described in detail below with reference to the attached drawing figures, wherein:

FIG. 1 is a data flow diagram illustrating an example of a process that may be performed by a system to automatically generate a storyboard based on a narrative, in accordance with some embodiments of the present disclosure;

FIG. 2 is a data flow diagram illustrating an example of a process for segmenting a plurality of scenes from input data representing a narrative, in accordance with some embodiments of the present disclosure;

FIG. 3 is a data flow diagram illustrating an example of a process for extracting a plurality of aspects from a scene, in accordance with some embodiments of the present disclosure;

FIG. 4 is a data flow diagram illustrating an example of a process for ranking a plurality of scenes based on their significance to a plot of a narrative, in accordance with some embodiments of the present disclosure;

FIG. 5 is a data flow diagram illustrating an example of a process for generating scene descriptions for a plurality of scenes, in accordance with some embodiments of the present disclosure;

FIG. 6 is a data flow diagram illustrating an example of a process for generating cinematographic details for a plurality of scenes, in accordance with some embodiments of the present disclosure;

FIG. 7 is a data flow diagram illustrating an example of a process for generating visual representations for a plurality of scenes, in accordance with some embodiments of the present disclosure;

FIG. 8 is a data flow diagram illustrating an example of a process for generating storyboard frames of a storyboard, in accordance with some embodiments of the present disclosure;

FIG. 9 is a data flow diagram illustrating an example of a process for generating intermediate storyboard frames for creating animatics, in accordance with some embodiments of the present disclosure;

FIG. 10 is a block diagram illustrating an example of a system that may perform one or more of the processes described herein, in accordance with some embodiments of the present disclosure;

FIG. 11 is a flow diagram illustrating an example of a method for generating a storyboard based on input data representative of a narrative, in accordance with some embodiments of the present disclosure;

FIG. 12 is a flow diagram illustrating an example of a method for generating storyboard frames corresponding to scenes of a narrative, in accordance with some embodiments of the present disclosure;

FIG. 13A is a block diagram of an example generative language model system suitable for use in implementing at least some embodiments of the present disclosure;

FIG. 13B is a block diagram of an example generative language model that includes a transformer encoder-decoder suitable for use in implementing at least some embodiments of the present disclosure;

FIG. 13C is a block diagram of an example generative language model that includes a decoder-only transformer architecture suitable for use in implementing at least some embodiments of the present disclosure;

FIG. 14 is a block diagram of an example computing device suitable for use in implementing at least some embodiments of the present disclosure; and

FIG. 15 is a block diagram of an example data center suitable for use in implementing at least some embodiments of the present disclosure.

### DETAILED DESCRIPTION

Systems and methods are disclosed related to automated storyboarding using generative Artificial Intelligence (AI)-based systems and applications. As described herein, the systems and methods of the present disclosure may, in some examples, provide an end-to-end pipeline that simplifies the storyboarding process by generating storyboards based on a basic story input from a user. For instance, the systems and methods of the present disclosure may use one or more AI models to automatically break down and divide (or “segment”) a story into scenes, generate or determine technical details (e.g., scene descriptions, cinematographic details, etc.) for the scene (e.g., each scene), as well as generate detailed visual representations of the scenes (e.g., each scene). Additionally, the systems and methods of the present disclosure may provide users with variations of storyboards and/or storyboard frames to choose from, allowing the users to explore different creative options. Further, the systems and methods of the present disclosure may review and enhance pre-existing storyboards to offer constructive feedback and improvements to ensure the best possible outcome.

By way of example, and not limitation, a system(s) may obtain input data corresponding to a story. In some examples, the input data may include one or more of text data, image data, audio data, or any other kind of data. For instance, the input data may include text data representing a narrative associated with the story. In some examples, the input data may be received from one or more client devices associated with one or more users. For instance, the user(s) may use the client device(s) (e.g., computers, smartphones, tablets, etc.) to send the input data representing the story/narrative to the system(s), where the system(s) may transform the input data into one or more storyboards.

As described herein, in various examples the system(s) may use a plurality of AI models and algorithms to transform the input data into the storyboard outputs. For instance, the system(s) may process the input data (e.g., text data) using one or more machine learning models (e.g., a first machine learning model(s)) to perform scene segmentation. That is, the systems(s) may use the machine learning model(s) to process the input data and identify scene boundaries by detecting changes in time, location, characters, and/or any other changes indicative of a transition between scenes. In some examples, the system(s) may engage in a scene segmentation process (which may include using the machine learning model(s) and/or other models or algorithms) to segment the input storyline into distinct scenes, thereby providing a robust foundation for subsequent stages of storyboard generation, such as extracting key elements, enriching scene descriptions, and creating visual representations. In some instances, the scene segmentation process may include, but is not limited to, preprocessing and/or tokenizing the text data, generating sentence embeddings, analyzing semantic similarities, applying topic modeling, tracking character and/or settings, detecting shifts, and clustering sentences.

For instance, as part of the scene segmentation process, the system(s) may preprocess the input data, which may include cleaning the text data (e.g., to remove extraneous characters, punctuation, formatting issues, etc.) and tokenizing the text data into smaller, manageable units such as words, subwords, phrases, etc. In some instances, the system(s) may generate sentence embeddings using models like Sentence-BERT, which may be used to convert the text data and/or preprocessed text data/tokens into numerical representations that capture the semantic meaning of each sentence. These embeddings may allow the system(s) to calculate semantic similarity between sentences by determining their cosine similarity, which may help identify relationships and patterns within the text. In some examples, the system(s) may apply one or more topic modeling techniques (e.g., Latent Dirichlet Allocation (LDA)) to detect thematic shifts in the narrative, which may indicate potential scene boundaries. Additionally, or alternatively, the system(s) may use one or more named entity recognition (NER) tools to track changes in characters, locations, and/or other key entities throughout the storyline. In some instances, the system(s) may use one or more custom scripts to detect shifts in temporal and/or spatial references, which may further assist in identifying transitions between scenes. Based at least on identifying these changes/transitions, the system(s) may group semantically related sentences into coherent scenes. For instance, the system(s) may apply or use one or more clustering algorithms (e.g., K-means) to group the related sentences into coherent scenes and ensure logical organization.

In various examples described herein, based at least on segmenting the storyline/input data into the plurality of scenes, the system(s) may generate one or more storyboard frames corresponding to one or more scenes of the plurality of scenes. In some instances, the generation of the storyboard frame(s) may include, but is not limited to, extracting key aspects or elements from the scenes (e.g., each scene), prioritizing certain scenes, generating scene information for the scenes (e.g., scene descriptions, cinematographic details, etc.), generating visual representations (e.g., images) of the scenes, and/or associating these per-scene features (e.g., scene descriptions, cinematographic details, and/or visual representations) with a storyboard frame(s) that corresponds to the scene(s). As described herein, the system(s) and/or one or more components, models, or algorithms associated with the system(s) may perform one or more of these processes.

In some examples, the system(s) may extract key aspects or elements from the scenes (e.g., each scene). For instance, based on the segmentation of the input data into the plurality of scenes, the system(s) may use the machine learning model(s) (e.g., a second machine learning model(s)) to process the per-scene input data and determine the key aspects or elements associated with the scenes (e.g., each scene). In some instances, the extraction of the key aspects of a respective scene may include identifying and analyzing various narrative and technical elements to create a detailed understanding of the respective scene. For instance, the system(s) may perform Named Entity Recognition (NER) (or any other techniques) to identify and classify key entities within the respective scene, such as characters, locations, objects, and/or other significant elements, which may help in tracking who or what is involved in the scenes (e.g., each scene) and establish context for the narrative flow.

Additionally, in some instances, the system(s) may use the machine learning model(s) to extract dialogue and/or sound details for the scenes (e.g., isolate dialogue lines and/or references to sound effects or music within the scene to capture auditory elements that contribute to the scene's atmosphere and/or storytelling), to detect significant events (e.g., detect critical plot points, turning points, or actions that are central to the progression of the story), and/or to conduct sentiment analysis (e.g., evaluate the emotional tone of the text to determine the mood or emotional context of the scene). In some examples, the system(s) and/or the machine learning models may synthesize these per-scene aspects to form a comprehensive scene understanding, and/or generate text data representing a combination of all the extracted aspects (e.g., entities, dialogue, sound details, significant events, sentiment, etc.) for the scenes (e.g., each scene).

In some examples, the system(s) may determine one or more key scenes of the plurality of scenes that are the most crucial or important to the plot for visualization. For instance, the system(s) may use the machine learning model(s) (e.g., a third machine learning model(s)) to identify (e.g., rank) and prioritize the scenes that are the most crucial or influential to the plot. In some instances, this may include the machine learning model(s) processing the segmented/per-scene text data and/or the extracted aspects for respective scenes (e.g., each scene) to rank the scenes in terms of their importance to the plot. For example, the system(s) may identify scenes that contain pivotal character decisions, major plot twists, climactic moments, and/or resolutions of key conflicts. These scenes may be ranked based on factors such as the density of emotional content, the number of plot dependencies connected to the scene, or narrative keywords identified through natural language processing. The system(s) may then prioritize these scenes for further processing/storyboarding.

In some instances, the system(s) may generate scene descriptions to be included in the storyboard frames corresponding to the scenes. For instance, the system(s) may use the machine learning model(s) (e.g., a fourth machine learning model(s)) to generate the scene descriptions based at least on processing the segmented/per-scene text data and/or the synthesized aspects for the respective scenes (e.g., each scene). In some examples, the scene descriptions may explain what happens in a particular scene visually, narratively, and/or technically. For example, a scene description from the movie Gladiator might include something like: “Setting: the camera opens with a wide shot of the towering Colosseum in Rome, its grandeur and scale awe-inspiring. The arena is filled with tens of thousands of roaring spectators. Dust and sunlight filter through the air, creating an almost divine glow on the sandy floor of the arena. Action: Maximus, shackled and wearing a modest gladiator's tunic, walks into the arena with a group of other captured fighters. His eyes scan the massive crowd, his expression a mixture of determination and disdain. The roar of the crowd grows louder as they cheer for the impending violence. Dialogue: A fellow gladiator whispers, ‘Stay close if you want to live.’”

As described herein, in some examples, the system(s) may also generate cinematographic details for the scenes/storyboard frames. For instance, the system(s) may use the machine learning model(s) (e.g., a fifth machine learning model(s)) to generate the cinematographic details for each scene based at least on one or more of the segmented/per-scene text data, the synthesized aspects for each scene, and/or the scene descriptions. In some examples, the machine learning model(s) used by the system(s) to generate the cinematographic details may include a custom trained machine learning model(s). For instance, the custom machine learning model(s) may be trained on breakdowns of existing media (e.g., films, animations, etc.) which may include, in some instances, camera shots (e.g., extent of the scene capture), camera angles (e.g., to set context), camera movements, composition, lighting, or any other relevant technical details.

In some instances, the system(s) may generate image data representing images depicting visual representations of scenes. For instance, the system(s) may use the machine learning model(s) (e.g., a sixth machine learning model(s)) to generate the image data corresponding to the visual representations of each scene based at least on one or more of the segmented/per-scene text data, the synthesized aspects for each scene, the scene descriptions, and/or the cinematographic details. In some examples, the machine learning model(s) used by the system(s) to generate the image data/visual representations may include text-to-image models (e.g., like DALL-E, MidJourney, StableDiffusion, DeepAI, etc.) and/or custom-trained Generative Adversarial Networks (GANs) to generate images from the input data (e.g., the scene descriptions, cinematographic details, etc.). In at least some instances, to ensure a consistent visual language and flow throughout the storyboard, the system(s) may generate the images (using the model(s)) based on the scene descriptions and the cinematographic details included or associated with each scene/storyboard frame.

In some instances, the system(s) may provide one or more user-controlled customization options. For instance, the system(s) may allow users to adjust the level of detail in the visual output and/or may enable artistic style transfers to alter visual styles as desired. Additionally, in some instances, the system(s) may provide users with different variations of scenes/storyboard frames to choose from, allowing them to explore various creative options. The system(s) may also offer tools for users to review and enhance storyboards (e.g., newly created or pre-existing storyboards), as well as provide constructive feedback and offer improvements.

In some examples, the system(s) may further support the extrapolation of storyboard frames to create animatics. That is, the system(s) may use the generated storyboard frames as input to create motion sequences that represent a version (e.g., preliminary version) of the final animation or video. For instance, the system(s) may interpolate between storyboard frames to generate smooth transitions (e.g., “in-between storyboard frames”) and may incorporate timing information, such as frame durations and scene sequencing, to simulate the pacing and flow of the final production. Additionally, the system(s) may apply motion effects to the camera angles, such as panning, zooming, or tilting, as described in the cinematographic details of each scene. In s ome examples, the system(s) may also generate, for the animatic, synchronized audio elements, such as dialogue, sound effects, or background music, to further enhance the animatic. By combining visual and auditory components, the system(s) may provide a comprehensive preview of the final production, enabling creators to evaluate and refine the narrative, pacing, and overall tone before moving into full production. This functionality may streamline the creative process, allowing users to iterate efficiently and ensure alignment with the intended creative vision.

Although many of the examples herein are described with respect to using machine learning models, and specifically language models (e.g., large language models (LLMs)), this is not intended to be limiting. For example, and without limitation, any of the various machine learning models, language models, and/or neural networks described herein may include any type of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-trained (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian Splat models, models with encoder-only architectures, models with decoder-only architectures, models with encoder-decoder architectures, generative machine learning models, large language models (LLMs), small language models (SLMs), vision language models (VLMs), multi-modal language models (MMLMs), and/or other types of machine learning models.

In some examples, the machine learning models described herein may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's Tensor®), and/or enterprise management data for telemetry (e.g., including identity, metrics, health checks, and/or monitoring).

In at least some instances, the machine learning models described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

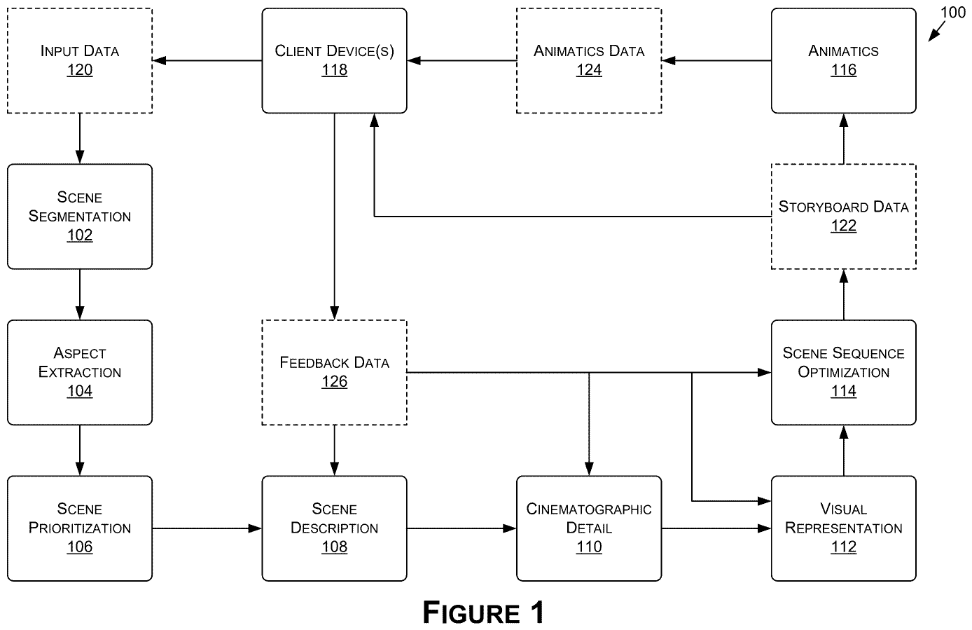

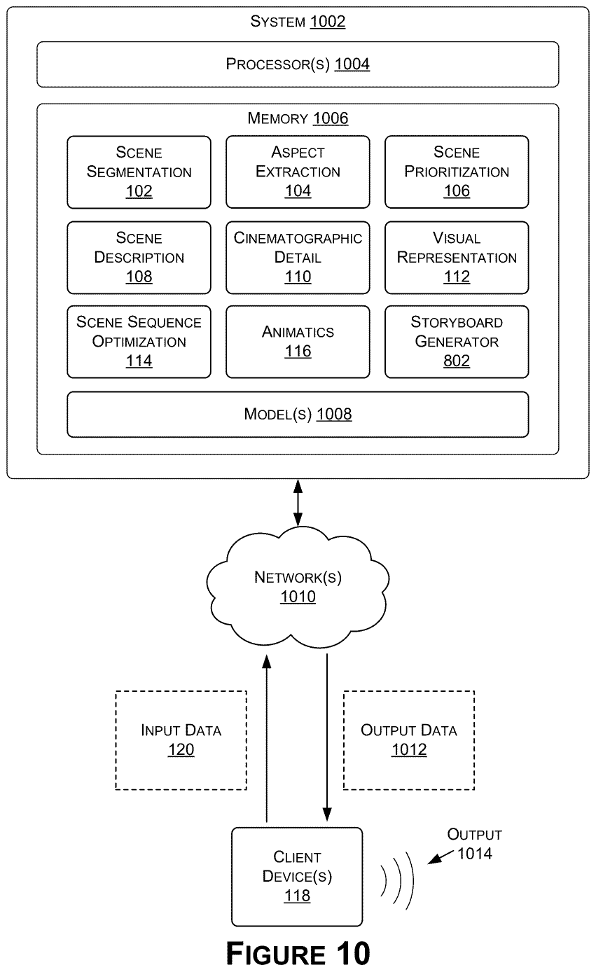

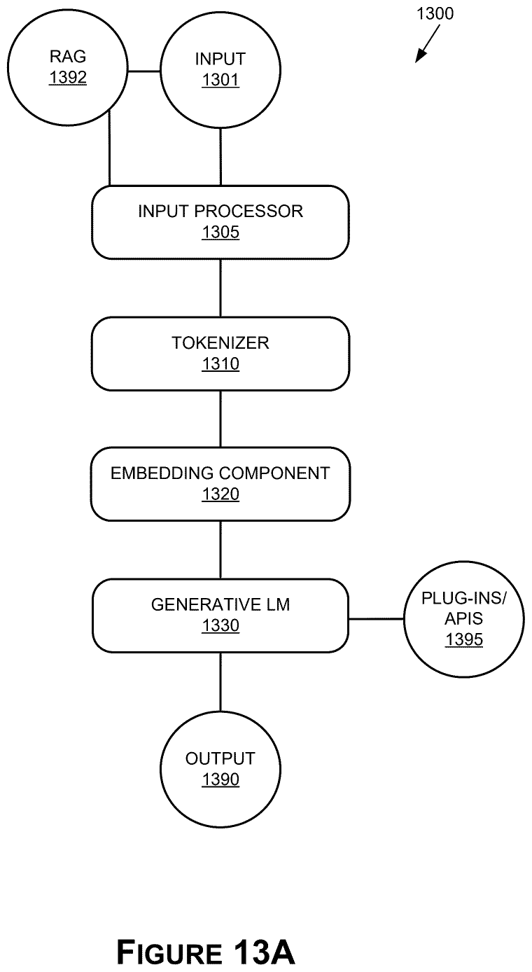

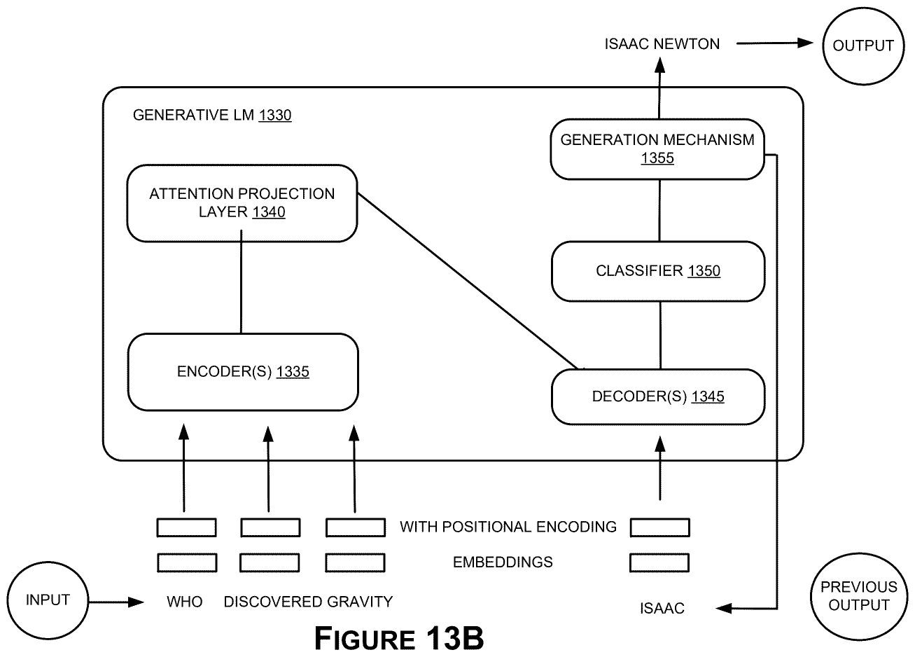

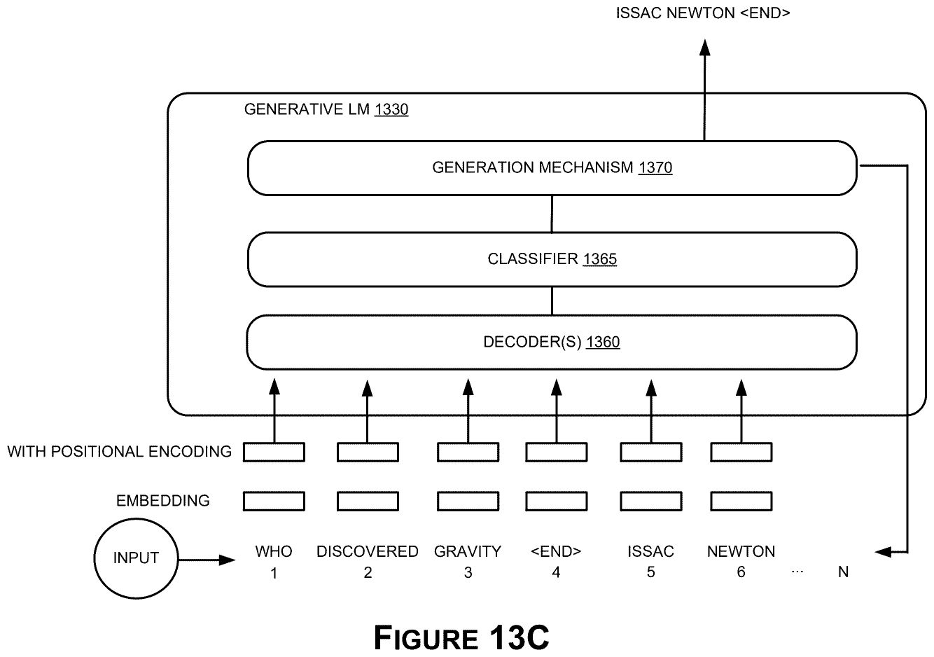

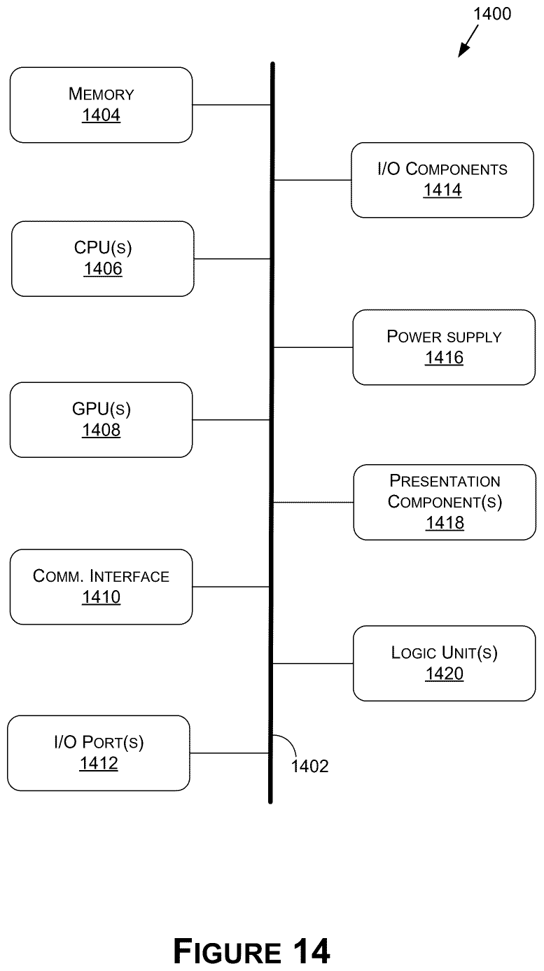

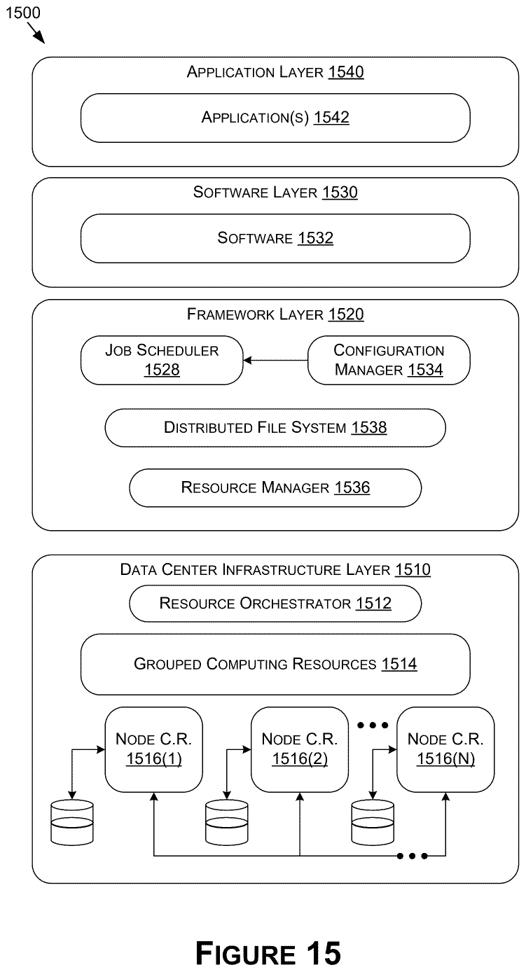

With reference to FIG. 1, FIG. 1 is a data flow diagram illustrating an example of a process 100 that may be performed by a system (e.g., the system 1002 of FIG. 10) to automatically generate a storyboard based on a narrative, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 13A-13C), one or more computing devices or components thereof (e.g., as described in FIG. 14), and/or one or more data centers or components thereof (e.g., as described in FIG. 15).

The process 100 may be implemented using, amongst additional or alternative components, a scene segmentation component 102, an aspect extraction component 104, a scene prioritization component 106, a scene description component 108, a cinematographic detail component 110, a visual representation component 112, a scene sequence optimization component 114, an animatics component 116, and one or more client devices 118. In some examples, one or more of these components may be part of or associated with a storyboard generation system, such as the system 1002 described herein.

As a brief overview, the process 100 may include the scene segmentation component 102 receiving, from the client device(s) 118, input data 120 (e.g., text data) representing a story (also referred to herein as a “narrative”). The scene segmentation component 102 may process and segment the input data 120 into a plurality of scenes. In some examples, the aspect extraction component 104 may process the segmented input data and extract one or more aspects (e.g., key aspects, elements, etc.) from each scene. The scene prioritization component 106 may, in some instances, rank and/or prioritize the scenes based on their significance to visualizing the plot of the story. The scene description component 108 may generate scene descriptions for each scene (e.g., each scene, each prioritized scene, etc.). Additionally, in some instances, the cinematographic detail component 110 may generate cinematographic details for each scene. The visual representation component 112 may, in various examples, process the scene descriptions and/or cinematographic details to generate visual representations (e.g., images) associated with each of the scenes. The scene sequence optimization component 114 may update or optimize the order of the scenes or storyboard frames corresponding to the scenes to ensure narrative cohesion, logical flow, and an engaging visual storytelling experience based on the plot structure and/or character arcs. Storyboard data 122 representing the storyboard frames may be sent to the client device(s) 118. In some examples, the animatics component 116 may use the storyboard data 122 to generate animatics data representing animatics corresponding to the storyboard, and the animatics data may also be sent to the client device(s) 118. In some instances, the client device(s) 118 may send feedback data 126 (e.g., representing requests, etc.) to one or more of the scene description component 108, the cinematographic detail component 110, the visual representation component 112, and/or the scene sequence optimization component 114. The feedback data 126 may represent requests to update or make changes to the storyboards, and the components may update the storyboards and/or frames in accordance with the requests.

In some examples, the input data 120 may include one or more of text data, image data, audio data, or any other kind of data. For instance, the input data 120 may include text data representing a narrative associated with the story. Additionally, or alternatively, the input data 120 may include audio data representing the narrative (e.g., a spoken version of the story, a recorded version of the story, etc.). In some examples, the input data 120 may be received from the client device(s) 118, which may be associated with one or more users. For instance, the user(s) may use the client device(s) 118 (e.g., computers, smartphones, tablets, etc.) to send the input data 120 representing the story/narrative to the storyboard generation system for transforming the input data 120 into the storyboard data 122 representing one or more storyboards.

As described herein, in various examples the storyboard generation system may use a plurality of AI models and algorithms to transform the input data 120 into the storyboard outputs. For instance, the scene segmentation component 102 may process the input data 120 (e.g., text data) using one or more machine learning models (e.g., a first machine learning model(s)) to perform scene segmentation. That is, the scene segmentation component 102 may use the machine learning model(s) to process the input data 120 and identify scene boundaries by detecting changes in time, location, characters, and/or any other changes indicative of a transition between scenes. In some examples, the scene segmentation component 102 may engage in a scene segmentation process (which may include using the machine learning model(s) and/or other models or algorithms) to segment the input storyline into distinct scenes, thereby providing a robust foundation for subsequent stages of storyboard generation, such as extracting key elements, enriching scene descriptions, and creating visual representations. In some instances, the scene segmentation process may include, but is not limited to, preprocessing and/or tokenizing the input data 120, generating sentence embeddings, analyzing semantic similarities, applying topic modeling, tracking character and/or settings, detecting shifts, and clustering sentences.

As part of the scene segmentation process, the scene segmentation component 102 may, in some instances, preprocess the input data 120, which may include cleaning (e.g., to remove extraneous characters, punctuation, formatting issues, etc.) and/or tokenizing the text data into smaller, manageable units such as words, subwords, phrases, etc. In some instances, the scene segmentation component 102 may generate sentence embeddings using models like Sentence-BERT, which may be used to convert the text data and/or preprocessed text data/tokens into numerical representations that capture the semantic meaning of each sentence. These embeddings may allow the scene segmentation component 102 to calculate semantic similarity between sentences by determining their cosine similarity, which may help identify relationships and patterns within the text. In some examples, the scene segmentation component 102 may apply one or more topic modeling techniques (e.g., Latent Dirichlet Allocation (LDA)) to detect thematic shifts in the narrative, which may indicate potential scene boundaries. Additionally, or alternatively, the scene segmentation component 102 may use one or more named entity recognition (NER) tools to track changes in characters, locations, and/or other key entities throughout the storyline. In some instances, the scene segmentation component 102 may use one or more custom scripts to detect shifts in temporal and/or spatial references, which may further assist in identifying transitions between scenes. Based at least on identifying these changes/transitions, the scene segmentation component 102 may group semantically related sentences into coherent scenes. For instance, the scene segmentation component 102 may apply or use one or more clustering algorithms (e.g., K-means) to group the related sentences into coherent scenes and ensure logical organization.

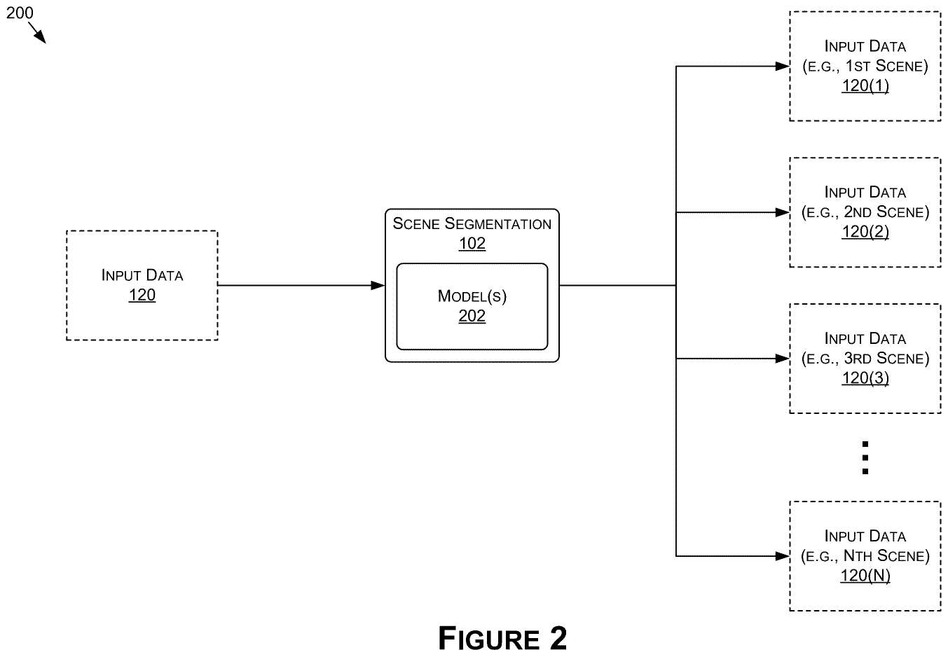

For instance, FIG. 2 is a data flow diagram illustrating an example of a process 200 for segmenting a plurality of scenes from input data 120 representing a narrative, in accordance with some embodiments of the present disclosure. As shown, the scene segmentation component 102 may include one or more models 202. The model(s) 202 may include one or more language models (e.g., large language models (LLMs), small language model (SLMs), vision language models (VLMs), multimodal language models (MMLMs)), or any other type of AI models. Additionally, or alternatively, the model(s) 202 may include Sentence-BERT models, topic modeling models (e.g., Latent Dirichlet Allocation (LDA)), NER models, custom scripts, and/or clustering algorithms (e.g., K-means). The scene segmentation component 102 may segment the input data 120 into a plurality of portions corresponding to respective scenes, such as a first input data portion 120(1) corresponding to a first scene, a second input data portion 120(2) corresponding to a second scene, a third input data portion 120(3) corresponding to a third scene, and so forth (e.g., for the Nth input data portion 120(N), “N” may correspond to any number). In such examples, the first input data portion 120(1) may include or correspond to one or more first words, sentences, portions, etc. of the input data 120 (e.g., text data), the second input data portion 120(2) may include or correspond to one or more second words, sentences, portions, etc. (which may be at least partially the same as or different from the first word(s), sentence(s), portion(s), etc.) of the input data 120, and so forth.

Referring back to the example of FIG. 1, the process 100 may include, in various examples, the aspect extraction component 104 extracting key aspects or elements from each scene (e.g., each segmented scene or input data portion 120(1)-120(N)). For instance, based on the segmentation of the input data 120 into the plurality of scenes, the aspect extraction component 104 may use the machine learning model(s) (e.g., a second machine learning model(s)) to process the per-scene input data (e.g., input data portions 120(1)-120(N) of the example of FIG. 2) 120 and determine the key aspects or elements associated with each scene. In some instances, the extraction of the key aspects of each scene may include identifying and analyzing various narrative and technical elements to create a detailed understanding of the scene. For instance, the aspect extraction component 104 may perform Named Entity Recognition (NER) (or any other techniques) to identify and classify key entities within the scene, such as characters, locations, objects, and/or other significant elements, which may help in tracking who or what is involved in each scene and establish context for the narrative flow.

Additionally, in some instances, the aspect extraction component 104 may use the machine learning model(s) to extract dialogue and/or sound details for each scene (e.g., isolate dialogue lines and/or references to sound effects or music within the scene to capture auditory elements that contribute to the scene's atmosphere and/or storytelling) to detect significant events (e.g., detect critical plot points, turning points, or actions that are central to the progression of the story) and/or to conduct sentiment analysis (e.g., evaluate the emotional tone of the text to determine the mood or emotional context of the scene). In some examples, the aspect extraction component 104 and/or the machine learning model(s) may synthesize these per-scene aspects to form a comprehensive scene understanding, and/or generate text data representing a combination of all the extracted aspects (e.g., entities, dialogue, sound details, significant events, sentiment, etc.) for each scene.

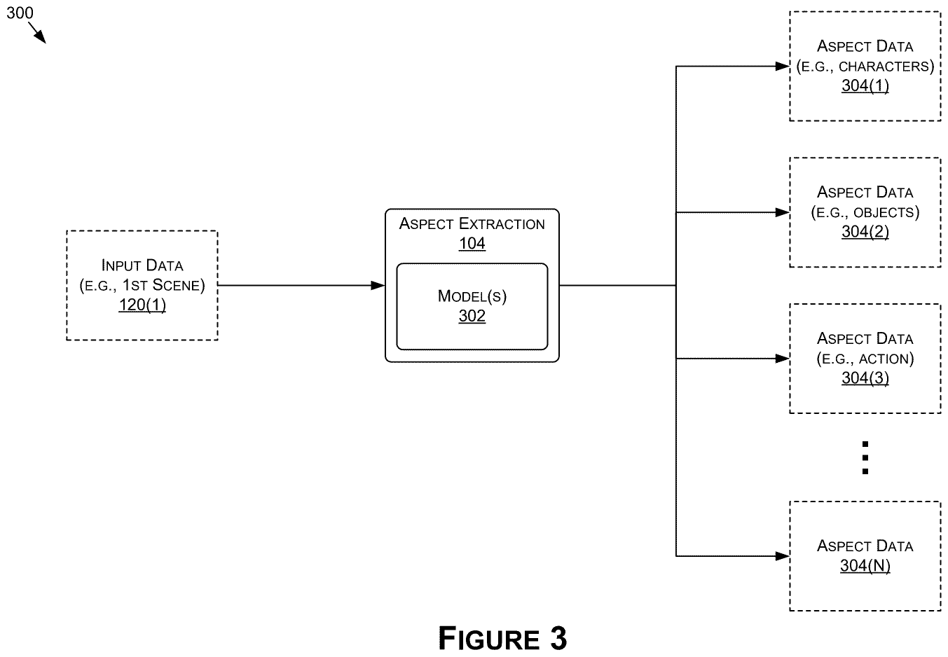

For instance, FIG. 3 is a data flow diagram illustrating an example of a process 300 for extracting a plurality of aspects from a scene, in accordance with some embodiments of the present disclosure. As shown, the aspect extraction component 104 may obtain the first input data portion 120(1) corresponding to the first scene (and/or any other input data portions corresponding to any other scenes) and use one or more machine learning models 302 to process the first input data portion 120(1) and extract a plurality of aspects associated with each scene, which may be represented by the aspect data 304(1)-304(N), where “N” may represent any number of extracted aspects. For instance, the first aspect data 304(1) may represent character-related aspects (e.g., which characters appear or are involved in the first scene), the second aspect data 304(2) may represent object-related aspects (e.g., objects that are present in the first scene), the third aspect data 304(3) may represent action-related aspects (e.g., what actions or events take place in the first scene), and so forth. In at least some embodiments, the model(s) 302 may include one or more language models. Additionally, or alternatively, the model(s) 302 may include any other type of models or processing algorithms.

Referring back to the example of FIG. 1, the process 100 may include, in some examples, the scene prioritization component 106 determining one or more key scenes of the plurality of scenes that are the most crucial or important to the plot for visualization. For instance, the scene prioritization component 106 may use the machine learning model(s) (e.g., a third machine learning model(s)) to identify (e.g., rank) and prioritize the scenes that are the most crucial or influential to the plot. In some instances, this may include the machine learning model(s) processing the segmented/per-scene input data (e.g., input data portions 120) and/or the extracted aspects (e.g., aspect data 304) for each scene to rank the scenes in terms of their importance to the plot. For example, the scene prioritization component 106 may use the model(s) to identify scenes that contain pivotal character decisions, major plot twists, climactic moments, and/or resolutions of key conflicts. These scenes may be ranked based on factors such as the density of emotional content, the number of plot dependencies connected to the scene, or narrative keywords identified through natural language processing. The scene prioritization component 106 may then prioritize these scenes for further processing/storyboarding.

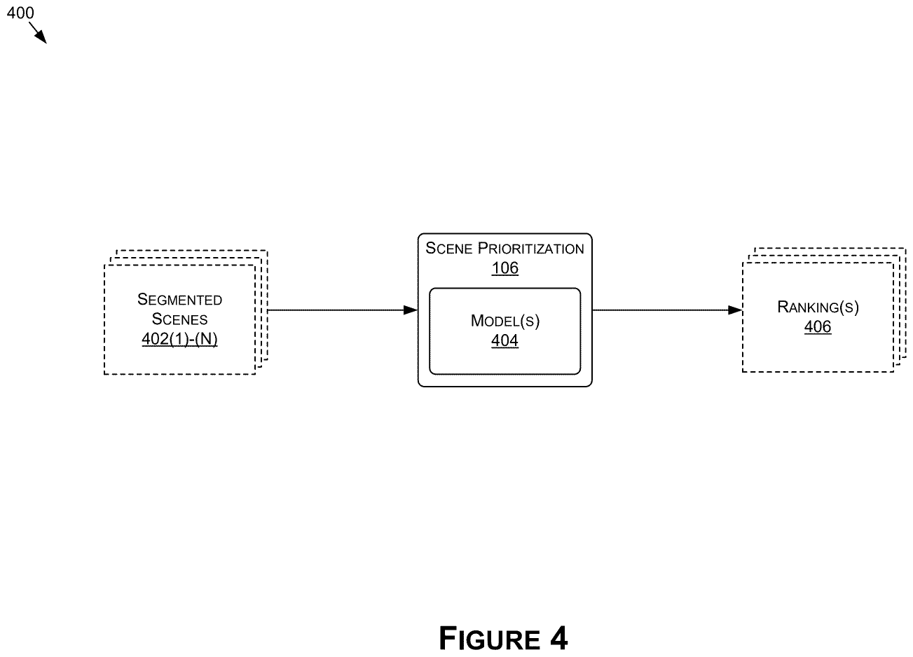

For instance, FIG. 4 is a data flow diagram illustrating an example of a process 400 for ranking a plurality of scenes based on their significance to a plot of a narrative, in accordance with some embodiments of the present disclosure. As shown, the scene prioritization component 106 may receive a plurality of segmented scenes 402(1)-402(N) (where “N” may represent any number of the segmented scenes 402). In some instances, the segmented scenes 402 may correspond to the input data portions 120(1)-120(N) described herein in the example of FIG. 2. That is, the segmented scenes 402 may include text data or other input data segmented from the input data 120. For instance, each one of the segmented scenes 402 may include text data (e.g., one or more words, sentences, paragraphs, etc.) corresponding to one or more scenes from the narrative/story. In some examples, the scene prioritization component 106 may use one or more models 404 (e.g., one or more machine learning models, language models, etc.) to process the segmented scenes 402 (e.g., process data representing or corresponding to the segmented scenes) to determine one or more rankings 406 for the segmented scenes 402. For instance, each segmented scene 402(1)-402(N) may be ranked based on its contribution to the plot of the story, its contribution to visualizing the plot of the story, or any other metric(s).

In some examples, the storyboard generation system may generate storyboard frames for each of the scenes of the narrative. Additionally, or alternatively, the storyboard generation system may generate story board frames for the scenes of the narrative that have a ranking above some threshold. For instance, the storyboard generation system may only generate storyboard frames for the scenes having a ranking that meets or exceeds the threshold. In this way, the storyboard generation system may generate storyboard frames for the scenes of the story that are most influential to visualizing the plot, thereby conserving resources and generating storyboards more efficiently than if the systems were to generate a storyboard frame for each scene, regardless of how influential each scene is to the plot. In some examples, the model(s) 404 relied upon by the scene prioritization component 106 to determine the ranking(s) 406 may include custom trained models that are trained to identify the most impactful scenes of the story.

Referring back to the example of FIG. 1, the process 100 may also include the scene description component 108 generating one or more scene descriptions to be included in the storyboard frames corresponding to the scenes (e.g., all the scenes and/or those scenes ranking above a threshold with respect to their contribution to visualizing the plot). For instance, the scene description component 108 may use the machine learning model(s) (e.g., a fourth machine learning model(s)) to generate the scene descriptions based at least on processing the segmented/per-scene text data and/or the synthesized aspects for each scene. In some examples, the scene descriptions may explain what happens in a particular scene/storyboard frame visually, narratively, and/or technically

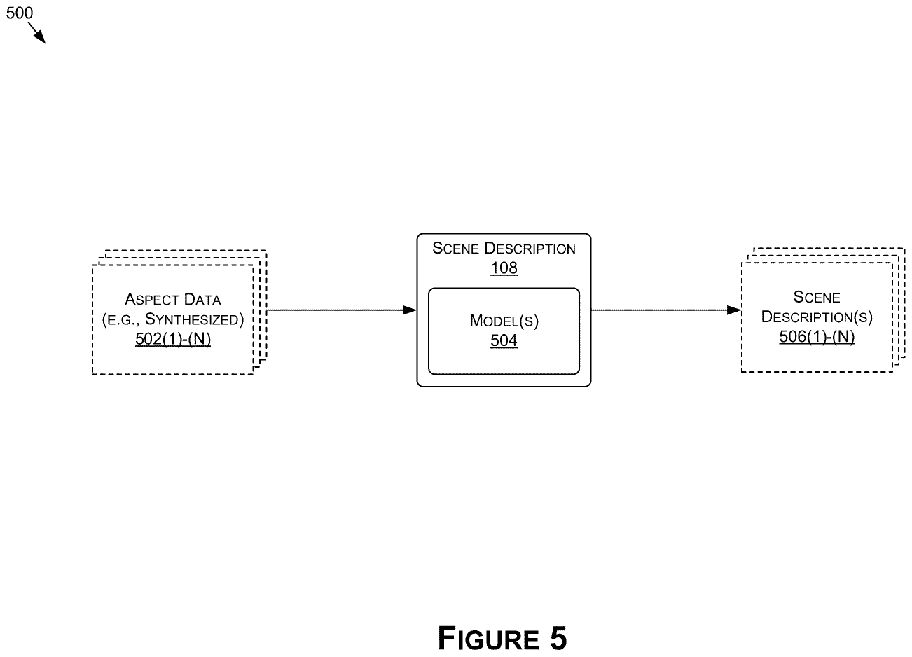

For instance, FIG. 5 is a data flow diagram illustrating an example of a process 500 for generating scene descriptions for a plurality of scenes, in accordance with some embodiments of the present disclosure. As shown, the scene description component 108 may receive aspect data 502(1)-502(N) corresponding to the various segmented scenes of the story. In some examples, each instance of the aspect data 502(1)-502(N) may correspond to each scene of the story. For instance, a first instance of the aspect data 502(1) may include one or more first aspects associated with a first scene, a second instance of the aspect data 502(2) may include one or more second aspects associated with a second scene of the story, and so forth. The scene description component 108 may use one or more model(s) 504 (e.g., language models, etc.) to process the aspect data 502 and generate one or more scene descriptions 506(1)-506(N) corresponding to each of the scenes/storyboard frames. For instance, a first scene description 506(1) may correspond to a first scene/storyboard frame, a second scene description 506(2) may correspond to a second scene/storyboard frame, and so forth.

Referring back to the example of FIG. 1, the process 100 may include the cinematographic detail component 110 generating cinematographic details for each scene/storyboard frame. For instance, the cinematographic detail component 110 may use the machine learning model(s) (e.g., a fifth machine learning model(s)) to generate the cinematographic details for each scene based at least on one or more of the segmented/per-scene text data, the synthesized aspects for each scene, and/or the scene descriptions. In some examples, the machine learning model(s) used by the cinematographic detail component 110 to generate the cinematographic details may include a custom trained machine learning model(s). For instance, the custom machine learning model(s) may be trained on breakdowns of existing media (e.g., films, animations, etc.) which may include, in some instances, camera shots (e.g., extent of the scene capture), camera angles (e.g., to set context), camera movements, composition, lighting, or any other relevant technical details.

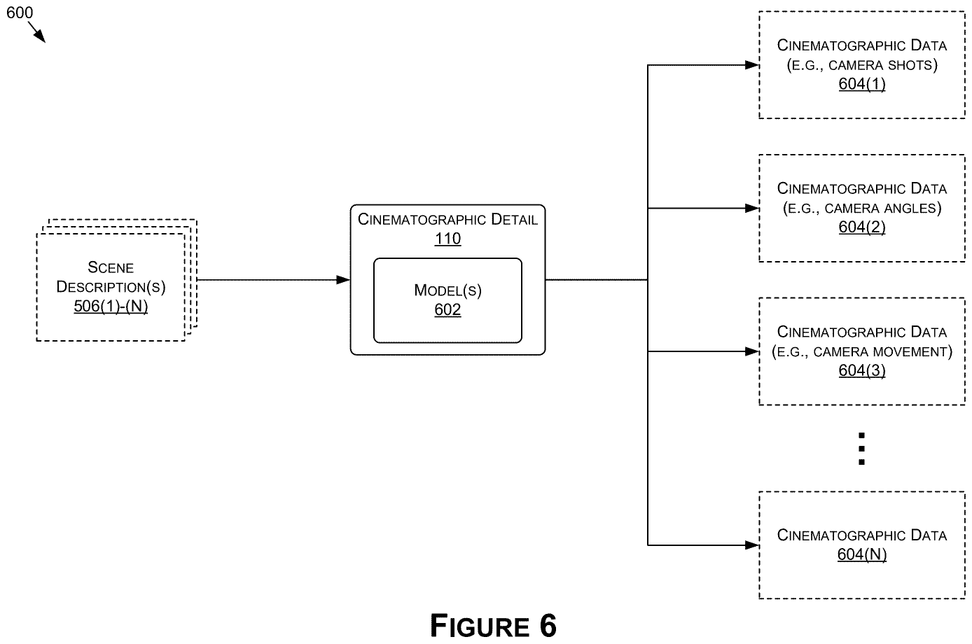

For example, FIG. 6 is a data flow diagram illustrating an example of a process 600 for generating cinematographic details for a plurality of scenes, in accordance with some embodiments of the present disclosure. As shown, the cinematographic detail component 110 may receive the scene description(s) 506(1)-506(N) and use one or more models 602 to process the scene description(s) 506(1)-506(N) and generate cinematographic data 604(1)-604(N) corresponding to specific scenes of the story. For instance, based at least on a first scene description 506(1), the cinematographic detail component 110 may use the model(s) 602 to generate first cinematographic data 604(1) representing cinematographic details related to types of camera shots to be used for a scene, generate second cinematographic data 604(2) representing cinematographic details related to camera angles to be used for the scene, generate third cinematographic data 604(3) representing cinematographic details related to camera movement to be used for the scene, and so forth. In some examples, the cinematographic detail component 110 may perform this same or similar process to generate cinematographic details for each of the scenes/storyboard frames based on their scene descriptions and/or other relevant information.

In some examples, the model(s) 602 may be custom trained on breakdowns of existing media (e.g., films, animations, etc.) which may include, in some instances, camera shots (e.g., extent of the scene capture), camera angles (e.g., to set context), camera movements, composition, lighting, or any other relevant technical details. For instance, the model(s) 602 may be trained to suggest use of extreme close-up shots to create intense emotion or highlight crucial detail, close-up shots to show emotions and details to create intimate connections with the audience, medium close-up shots to focus on a subject's facial expressions and body language, and so forth. The model(s) 602 may also be trained similarly for suggesting camera angles, movements, or any other cinematographic details for shooting a scene. For instance, the model(s) 602 may be trained using training data sets that include scene descriptions as input data and cinematographic details as ground truth data.

Referring back to the example of FIG. 1, the process 100 may include, in some instances, the visual representation component 112 generating visual representations of scenes for the storyboard frames. For instance, the visual representation component 112 may use the machine learning model(s) (e.g., a sixth machine learning model(s)) to generate image data corresponding to the visual representations of each scene based at least on one or more of the segmented/per-scene text data, the synthesized aspects for each scene, the scene descriptions, and/or the cinematographic details. In some examples, the machine learning model(s) used by the visual representation component 112 to generate the image data/visual representations may include text-to-image models (e.g., like DALL-E, MidJourney, StableDiffusion, DeepAI, etc.) and/or custom-trained Generative Adversarial Networks (GANs) to generate images from the input data 120 (e.g., the scene descriptions, cinematographic details, etc.). In at least some instances, to ensure a consistent visual language and flow throughout the storyboard, the visual representation component 112 may generate the images (using the model(s)) based on the scene descriptions and the cinematographic details included or associated with each scene/storyboard frame.

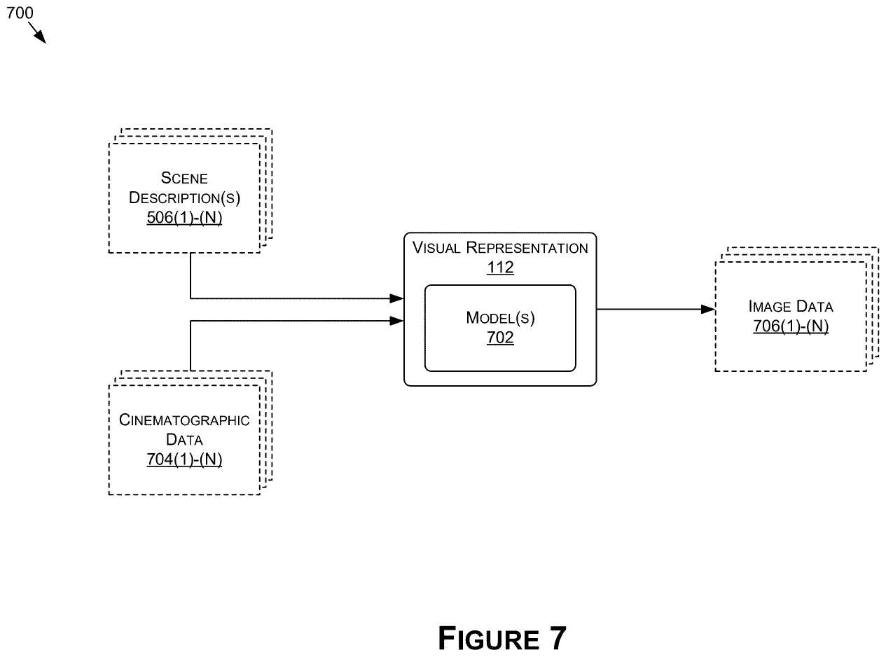

For instance, FIG. 7 is a data flow diagram illustrating an example of a process 700 for generating visual representations for a plurality of scenes, in accordance with some embodiments of the present disclosure. As shown, the visual representation component 112 may receive the scene description(s) 506(1)-506(N) and cinematographic data 704(1)-704(N) for each scene/storyboard frame, and use one or more model(s) 702 to generate image data 706(1)-706(N) representing images depicting the visual representation(s) of each scene. For instance, the visual representation component 112 may use the model(s) 702 to generate first image data 706(1) representing a first image for a first scene/storyboard frame based on processing a first scene description 506(1) and first cinematographic data 704(1) corresponding to the first scene/storyboard frame, generate second image data 706(2) representing a second image for a second scene/storyboard frame based on processing a second scene description 506(2) and second cinematographic data 704(2) corresponding to the second scene/storyboard frame, and so forth. In some examples, the model(s) 702 may include text-to-image models, custom-trained GANs, or any other type of AI models (e.g., generative-AI models).

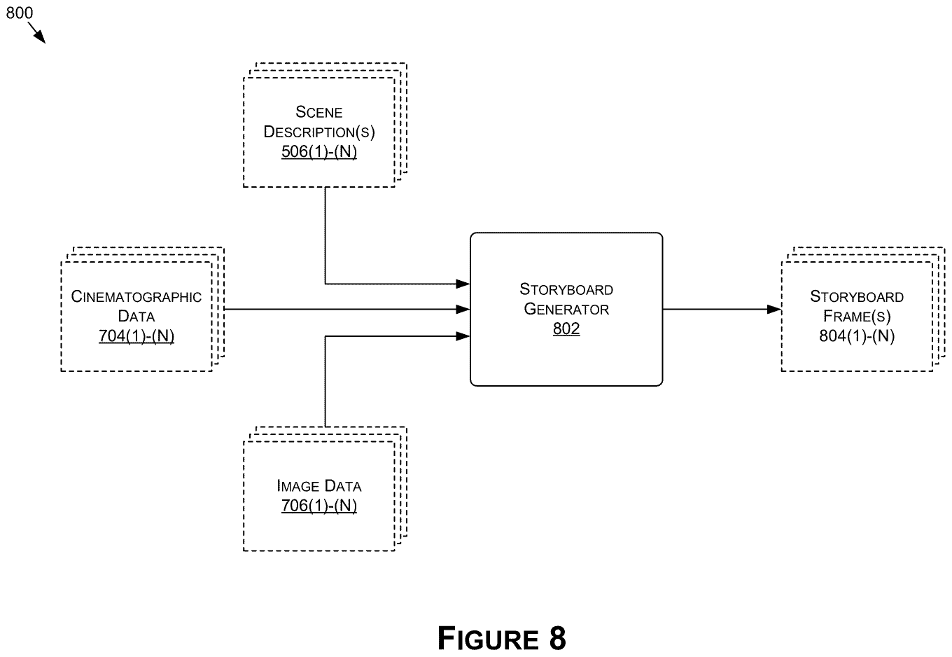

In some examples, the storyboard generation system may combine the scene descriptions, cinematographic details, and the visual scene representations to generate individual storyboard frames of the storyboard, where each storyboard frame may correspond to one or more scenes of the story. For instance, FIG. 8 is a data flow diagram illustrating an example of a process 800 for generating storyboard frames of a storyboard, in accordance with some embodiments of the present disclosure. As shown, a storyboard generator 802 may receive the scene description(s) 506(1)-506(N), the cinematographic data 704(1)-704(N), and the image data 706(1)-706(N) for each scene and combine some or all of this information to generate one or more storyboard frames 804(1)-804(N). For instance, the storyboard generator may generate a first storyboard frame 804(1) corresponding to one or more first scenes of the story based at least on a first scene description 506(1), first cinematographic data 704(1), and first image data 706(1), generate a second storyboard frame 804(2) corresponding to one or more second scenes of the story based at least on a second scene description 506(2), second cinematographic data 704(2), and second image data 706(2), and so forth.

Referring back to the example of FIG. 1, the process 100 may include the scene sequence optimization component 114 updating or optimizing the order of the storyboard frames (e.g., the storyboard frame(s) 804) corresponding to the scenes. For instance, the scene sequence optimization component 114 may modify or otherwise determine the optimal order of the storyboard frames within the storyboard to ensure narrative cohesion, logical flow, and/or an engaging visual storytelling experience based on the plot structure and/or character arcs. The process 100 may also include the scene sequence optimization component 114 sending the storyboard data 122 representing the storyboard (and its various frames) to the client device(s) 118.

In some instances, the storyboard generation system may provide one or more user-controlled customization options. For instance, the storyboard generation system may allow users of the client device(s) 118 to adjust the level of detail in the visual output and/or may enable artistic style transfers to alter visual styles as desired. Additionally, in some instances, the storyboard generation system may provide users of the client device(s) 118 with different variations of scenes/storyboard frames to choose from, allowing them to explore various creative options. That is, the storyboard data 122 may represent a variety of different storyboard versions and/or storyboard frame versions, and the users of the client device(s) 118 may select their preferred versions. The storyboard generation system may also offer tools for users to review and enhance storyboards (e.g., newly created or pre-existing storyboards), as well as provide constructive feedback and offer improvements.

In some examples, feedback data 126 may be obtained from the client device(s) 118, and the feedback data may be used by the storyboard generation system to update scene descriptions, update cinematographic details, update visual representations, update orders of storyboard frames, remove storyboard frames, etc. In some examples, the feedback data 126 may represent a selection of a preferred storyboard frame/storyboard version, a request to modify cinematographic details for shooting a scene, a request to update scene descriptions, or any other details. For instance, the scene description component 108, the cinematographic detail component 110, the visual representation component 112, and/or the scene sequence optimization component 114 may receive the feedback data 126 from the client device(s) 118 and use the feedback data to update or modify their outputs.

In some examples, the storyboard generation system may further support the extrapolation of storyboard frames to create animatics. For instance, the process 100 may include the animatics component 116 using the storyboard data 122 as input to create animatics data 124 and/or other motion sequences that represent a preliminary version of the final animation or video. For instance, the animatics component 116 may interpolate between storyboard frames to generate smooth transitions (e.g., “in-between storyboard frames”) and may incorporate timing information, such as frame durations and scene sequencing, to simulate the pacing and flow of the final production. Additionally, the animatics component 116 may apply motion effects to the camera angles, such as panning, zooming, or tilting, as described in the cinematographic details of each scene. In some examples, the animatics component 116 may also generate, for the animatic, synchronized audio elements, such as dialogue, sound effects, or background music, to further enhance the animatic. By combining visual and auditory components, the animatics component 116 may provide a comprehensive preview of the final production, enabling creators to evaluate and refine the narrative, pacing, and overall tone before moving into full production. This functionality may streamline the creative process, allowing users to iterate efficiently and ensure alignment with the intended creative vision.

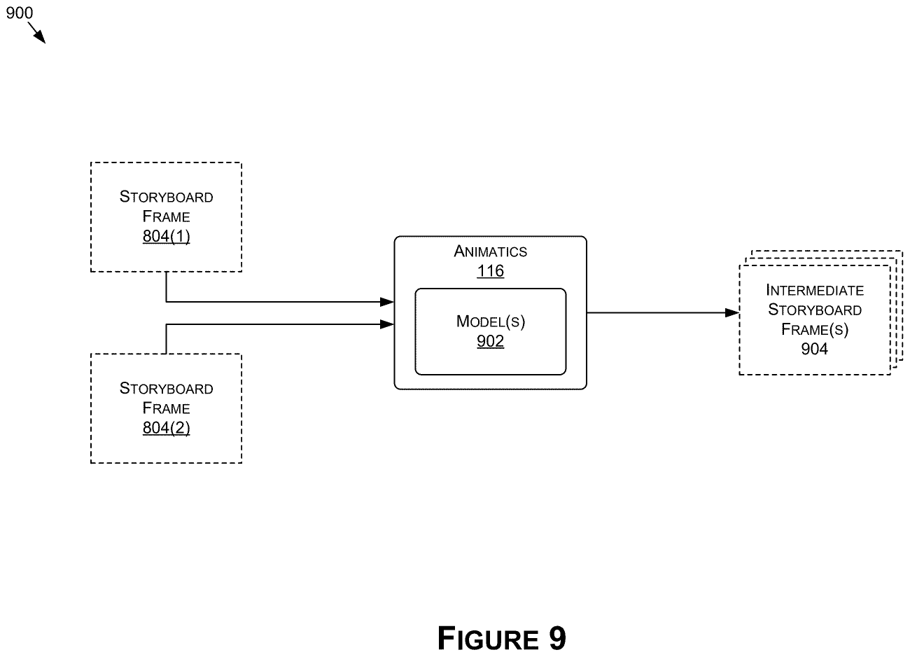

For instance, FIG. 9 is a data flow diagram illustrating an example of a process 900 for generating intermediate storyboard frames for creating animatics, in accordance with some embodiments of the present disclosure. As shown, the animatics component 116 may receive a first storyboard frame 804(1) and a second storyboard frame 804(2), and use one or more model(s) 902 to generate one or more intermediate storyboard frames 904. In some examples, the first storyboard frame 804(1) and the second storyboard frame 804(2) may be sequential frames of the storyboard. That is, in the storyboard, the first storyboard frame 804(1) may correspond to a first point in time in the story and the second storyboard frame 804(2) may correspond to a second point in time in the story that comes after the first point in time. In such examples, the intermediate storyboard frame(s) 904 may correspond to one or more points in time that intervene the first and the second point in time.

Referring now to FIG. 10, FIG. 10 is a block diagram illustrating an example of a system 1002 that may perform one or more of the processes described herein, in accordance with some embodiments of the present disclosure. As shown, the system 1002 (which may represent, and/or include, an example computing device(s) 1400 and/or an example data center 1500) may include one or more processors 1004 (which may be similar to, and/or include, one or more central processing units 1406 and/or one or more graphics processing units 1408) and memory 1006 (which may be similar to, and/or include, a memory 1404). For instance, the memory 1006 may store one or more of the scene segmentation component 102, the aspect extraction component 104, the scene prioritization component 106, the scene description component 108, the cinematographic detail component 110, the visual representation component 112, the scene sequence optimization component 114, the animatics component 116, the storyboard generator 802, and/or one or more model(s) 1008 (which may correspond to any of the model(s) described herein and in the examples of FIGS. 1-9). Additionally, the processor(s) 1004 may execute one or more of the scene segmentation component 102, the aspect extraction component 104, the scene prioritization component 106, the scene description component 108, the cinematographic detail component 110, the visual representation component 112, the scene sequence optimization component 114, the animatics component 116, the storyboard generator 802, and/or the model(s) 1008 to perform one or more of the processes described herein.

Although depicted in the example of FIG. 10 as being stored in the memory 1006 of the system 1002, in some examples, one or more of the scene segmentation component 102, the aspect extraction component 104, the scene prioritization component 106, the scene description component 108, the cinematographic detail component 110, the visual representation component 112, the scene sequence optimization component 114, the animatics component 116, and/or the storyboard generator 802 may represent LLM-based agents of an agentic AI architecture. For instance, these agents may include one or more language models or other AI models for reasoning through tasks, as well as one or more tools for accomplishing the tasks.

Additionally, as shown by the example of FIG. 10, the system 1002 may receive, over one or more networks 1010, the input data 120 from the client device(s) 118. For instance, the client device(s) 118 may use one or more input devices, such as one or more microphones, keyboards, etc. to generate the input data 120. The client device(s) 118 may also include one or more output devices, such as one or more speakers, one or more displays, etc. to output 1014 sound and/or image data associated with the output data 1012. For instance, in some examples, the input data 120 may represent a narrative of a story and the output data 1012 may represent a storyboard and/or animatics associated with the story. While the example of FIG. 10 appears to illustrate the output 1014 as being associated with audio, in other examples, the output 1014 may include any other type of output, such as content that is visually displayed by the client device(s) 118 (e.g., on a screen).

In some examples, the model(s) 1008 (and other models described herein) may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) 1008 (e.g., weights and biases). In some instances, such as where the model(s) 1008 is small enough (e.g., has a small enough number of parameters), the model(s) 1008 may be included within the container itself. In other examples—such as where the model(s) 1008 is large—the model(s) 1008 may be hosted/stored in the cloud (e.g., in a data center) and/or may be hosted on-premises and/or at the edge (e.g., on a local server or computing device, but outside of the container). In such embodiments, the model(s) 1008 may be accessible via one or more APIs—such as REST APIs. As such, and in some embodiments, the model(s) 1008 described herein may be deployed as an inference microservice to accelerate deployment of a model(s) 1008 on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's Tensor®), and/or enterprise management data for telemetry (e.g., including identity, metrics, health checks, and/or monitoring).

In at least some instances, the model(s) 1008 may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) 1008 (e.g., that has been optimized for high performance inference), an inference runtime software to execute the model(s) 1008 and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s) 1008. When replacing or updating, the software that performs the replacement/updating may maintain user configurations of the inference runtime software and enterprise management software.

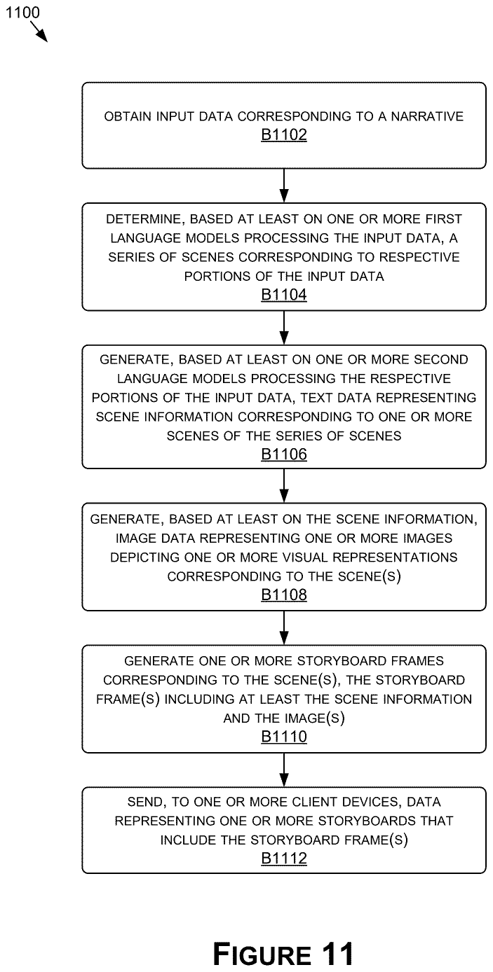

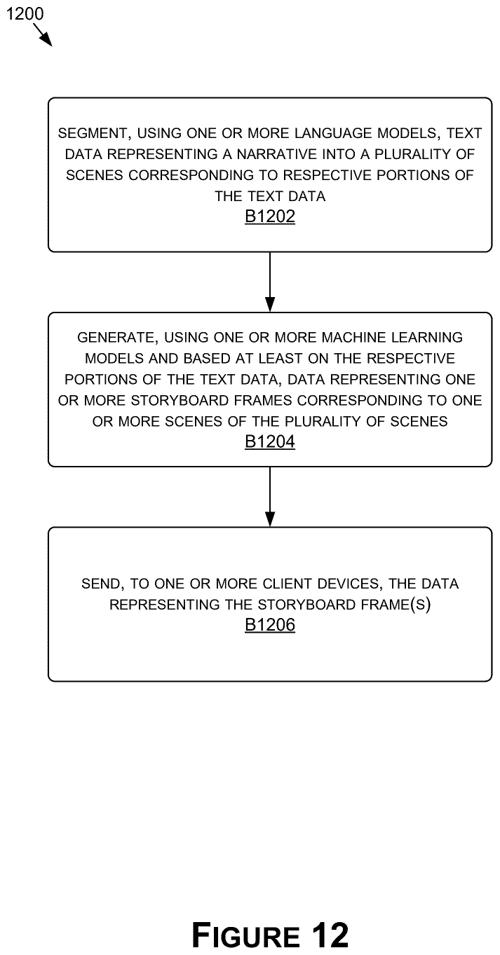

Now referring to FIGS. 11 and 12, each block of methods 1100 and 1200, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 1100 and 1200 may be described, by way of example, with respect to the systems and examples of FIGS. 1-10. However, these methods may additionally or alternatively be executed by any one system, or any combination of systems, including, but not limited to, those described herein.

FIG. 11 is a flow diagram illustrating an example of a method 1100 for generating a storyboard based on input data representative of a narrative, in accordance with some embodiments of the present disclosure. The method 1100, at block B1102, includes obtaining input data corresponding to a narrative. For instance, the scene segmentation component 102 of the storyboard generation system may obtain the input data 120 corresponding to the narrative. For instance, the input data 120 may include text data representing the narrative of a storyline. Additionally, or alternatively, the input data 120 may include audio data, image data, or any other kind of data, and the storyboard generation system may convert the input data into text and/or other data types (e.g., tokens) prior to further processing.

The method 1100, at block B1104, includes determining, based at least on one or more first language models processing the input data, a series of scenes corresponding to respective portions of the input data. For instance, the scene segmentation component 102 may process the input data 120 using the model(s) 202 to segment the input data 120 into the plurality of input data portions 120(1)-120(N), where each input data portion may correspond to a specific scene of the series of scenes.

The method 1100, at block B1106, includes generating, based at least on one or more second language models processing the respective portions of the input data, text data representing scene information corresponding to one or more scenes of the series of scenes. In some examples, the scene information may include scene descriptions and/or cinematographic details for each scene. For example, the scene description component 108 may process the input data portions 120(1)-120(N) and/or the aspect data 502(1)-502(N) to generate text data representing the scene description(s) 506. Additionally, or alternatively, the cinematographic detail component 110 may process the input data portions 120(1)-120(N), the aspect data 502(1)-502(N), and/or the scene description(s) 506(1)-506(N) to generate text data representing the cinematographic details (e.g., cinematographic data 604 and/or 704) for each scene.

The method 1100, at block B1108, includes generating, based at least on the scene information, image data representing one or more images depicting one or more visual representations corresponding to the scene(s). For instance, the visual representation generator 112 may generate the image data 706(1)-706(N) representing the image(s) depicting the visual representation(s) corresponding to the scene(s) based at least on the scene information, which may include the scene description(s) 506(1)-506(N) and/or the cinematographic data 704(1)-704(N).

The method 1100, at block B1110, includes generating one or more storyboard frames corresponding to the scene(s), the storyboard frame(s) including at least the scene information and the image(s). For instance, the storyboard generator 802 may generate the storyboard frame(s) 804(1)-804(N) corresponding to the scene(s). In some examples, to generate the storyboard frame(s) 804(1)-804(N) corresponding to the scene(s), the storyboard generator 802 may combine, for each scene, the respective scene description(s) 506(1)-506(N), cinematographic data 704(1)-704(N), and image data 706(1)-706(N) corresponding to that particular scene.

The method 1100, at block B1112, includes sending, to one or more client devices, data representing one or more storyboards that include the storyboard frame(s). For instance, the storyboard generation system may send, to the client device(s) 118, the storyboard data 122 representing the storyboard(s) that include the storyboard frame(s).

FIG. 12 is a flow diagram illustrating an example of a method 1200 for generating storyboard frames corresponding to scenes of a narrative, in accordance with some embodiments of the present disclosure. The method 1200, at block B1202, includes segmenting, using one or more language models, text data representing a narrative into a plurality of scenes corresponding to respective portions of the text data. For instance, the scene segmentation component 102 may use the model(s) 202 to segment text data within the input data 120 into the plurality of scenes corresponding to the respective portions of the text data. In other words, the system may divide the text data into various portions (e.g., words, sentences, paragraphs, etc.) where each portion corresponds to a scene of the story.

The method 1200, at block B1204, includes generating, using one or more machine learning models and based at least on the respective portions of the text data, data representing one or more storyboard frames corresponding to one or more scenes of the plurality of scenes. For instance, the storyboard generation system may use the model(s) 1008 to generate the data representing the storyboard frame(s) 804(1)-804(N) that correspond to the scene(s) of the story/narrative. In some examples, this may include the scene description component generating scene descriptions to be included in each storyboard frame for each scene, the cinematographic detail component 110 generating cinematographic information for each scene/storyboard frame, and/or the visual representation component 112 generating image data corresponding to the visual representations for each scene/storyboard frame.

The method 1200, at block B1206, includes sending, to one or more client devices, the data representing the storyboard frame(s). For instance, the storyboard generation system may send, to the client device(s) 118, the storyboard data 122 representing the storyboard frame(s). In some examples, the storyboard generation system may include computer executable instructions to cause the client device(s) 118 to output (e.g., cause presentation of) the storyboard frame(s) on a display(s) of the client device(s) 118.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 13A is a block diagram of an example generative language model system 1300 suitable for use in implementing at least some embodiments of the present disclosure. In the example illustrated in FIG. 13A, the generative language model system 1300 includes a retrieval augmented generation (RAG) component 1392, an input processor 1305, a tokenizer 1310, an embedding component 1320, plug-ins/APIs 1395, and a generative language model (LM) 1330 (which may include an LLM, a SLM, a VLM, a multi-modal LM, etc.).

At a high level, the input processor 1305 may receive an input 1301 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1330 (e.g., LLM/SLM/VLM/MMLM/etc.). In some embodiments, the input 1301 includes plain text in the form of one or more sentences, paragraphs, and/or documents. Additionally or alternatively, the input 1301 may include numerical sequences, precomputed embeddings (e.g., word or sentence embeddings), and/or structured data (e.g., in tabular formats, JSON, or XML). In some implementations in which the generative LM 1330 is capable of processing multi-modal inputs, the input 1301 may combine text (or may omit text) with image data, audio data, video data, design data, USD data, and/or other types of input data, such as but not limited to those described herein. Taking raw input text as an example, the input processor 1305 may prepare raw input text in various ways. For example, the input processor 1305 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1305 may remove stopwords to reduce noise and focus the generative LM 1330 on more meaningful content. The input processor 1305 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1392 (which may include one or more RAG models, and/or may be performed using the generative LM 1330 itself) may be used to retrieve additional information to be used as part of the input 1301 or prompt. RAG may be used to enhance the input to the LLM/SLM/VLM/MMLM/etc. with external knowledge, so that answers to specific questions or queries or requests are more relevant—such as in a case where specific knowledge is required. The RAG component 1392 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 1301 may be generated using the query or input to the model (e.g., a question, a request, etc.) in addition to data retrieved using the RAG component 1392. In some embodiments, the input processor 1305 may analyze the input 1301 and communicate with the RAG component 1392 (or the RAG component 1392 may be part of the input processor 1305, in embodiments) in order to identify relevant text and/or other data to provide to the generative LM 1330 as additional context or sources of information from which to identify the response, answer, or output 1390, generally. For example, where the input indicates that the user is interested in a desired tire pressure for a particular make and model of vehicle, the RAG component 1392 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1392 may retrieve a prior stored conversation history—or at least a summary thereof—and include the prior conversation history along with the current ask/request as part of the input 1301 to the generative LM 1330.

The RAG component 1392 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1392 and the embeddings of the chunks along with the embeddings of the query may be compared to identify the most similar/related embeddings to the query, which may be supplied to the generative LM 1330 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1392 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1310 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1330 to understand morphological variations and handle out-of-vocabulary words more effectively. Character-based tokenization represents each character as a separate token, enabling the generative LM 1330 to process text at a fine-grained level. The choice of tokenization strategy may depend on factors such as the language being processed, the task at hand, and/or characteristics of the training dataset. As such, the tokenizer 1310 may convert the (e.g., processed) text into a structured format according to tokenization schema being implemented in the particular embodiment.

The embedding component 1320 may use any known embedding technique to transform discrete tokens into (e.g., dense, continuous vector) representations of semantic meaning. For example, the embedding component 1320 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1301 includes image data/video data/etc., the input processor 1301 may resize the data to a standard size compatible with format of a corresponding input channel and/or may normalize pixel values to a common range (e.g., 0 to 1) to ensure a consistent representation, and the embedding component 1320 may encode the image data using any known technique (e.g., using one or more convolutional neural networks (CNNs) to extract visual features). In some implementations in which the input 1301 includes audio data, the input processor 1301 may resample an audio file to a consistent sampling rate for uniform processing, and the embedding component 1320 may use any known technique to extract and encode audio features—such as in the form of a spectrogram (e.g., a mel-spectrogram). In some implementations in which the input 1301 includes video data, the input processor 1301 may extract frames or apply resizing to extracted frames, and the embedding component 1320 may extract features such as optical flow embeddings or video embeddings and/or may encode temporal information or sequences of frames. In some implementations in which the input 1301 includes multi-modal data, the embedding component 1320 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1330 and/or other components of the generative LM system 1300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1320 may apply an encoded representation of the input 1301 to the generative LM 1330, and the generative LM 1330 may process the encoded representation of the input 1301 to generate an output 1390, which may include responsive text and/or other types of data.

As described herein, in some embodiments, the generative LM 1330 may be configured to access or use—or capable of accessing or using—plug-ins/APIs 1395 (which may include one or more plug-ins, application programming interfaces (APIs), databases, data stores, repositories, etc.). For example, for certain tasks or operations that the generative LM 1330 is not ideally suited for, the model may have instructions (e.g., as a result of training, and/or based on instructions in a given prompt, such as those retrieved using the RAG component 1392) to access one or more plug-ins/APIs 1395 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1395 to the plug-in/API 1395, the plug-in/API 1395 may process the information and return an answer to the generative LM 1330, and the generative LM 1330 may use the response to generate the output 1390. This process may be repeated—e.g., recursively—for any number of iterations and using any number of plug-ins/APIs 1395 until an output 1390 that addresses each ask/question/request/process/operation/etc. from the input 1301 can be generated. As such, the model(s) may not only rely on its own knowledge from training on a large dataset(s) and/or from data retrieved using the RAG component 1392, but also on the expertise or optimized nature of one or more external resources—such as the plug-ins/APIs 1395.

FIG. 13B is a block diagram of an example implementation in which the generative LM 1330 includes a transformer encoder-decoder. For example, assume input text such as “Who discovered gravity” is tokenized (e.g., by the tokenizer 1310 of FIG. 13A) into tokens such as words, and each token is encoded (e.g., by the embedding component 1320 of FIG. 913A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1335 of the generative LM 1330.

In an example implementation, the encoder(s) 1335 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1340 may convert the context vector into attention vectors (keys and values) for the decoder(s) 1345.

In an example implementation, the decoder(s) 1345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1335, in an example transformer architecture, each token (e.g., word) flows through a separate path in the decoder(s) 1345. During a first pass, the decoder(s) 1345, a classifier 1350, and a generation mechanism 1355 may generate a first token, and the generation mechanism 1355 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1335, except that it creates its queries from the layer below it and takes the keys and values (e.g., matrix) from the output of the encoder(s) 1335.

As such, the decoder(s) 1345 may output some decoded (e.g., vector) representation of the input being applied during a particular pass. The classifier 1350 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1355 may select or sample a word or token based on a corresponding predicted probability (e.g., select the word with the highest predicted probability) and append it to the output from a previous pass, generating each word or token sequentially. The generation mechanism 1355 may repeat the process, triggering successive decoder inputs and corresponding predictions until selecting or sampling a symbol or token that represents the end of the response, at which point, the generation mechanism 1355 may output the generated response.

FIG. 13C is a block diagram of an example implementation in which the generative LM 1330 includes a decoder-only transformer architecture. For example, the decoder(s) 1360 of FIG. 13C may operate similarly as the decoder(s) 1345 of FIG. 13B except each of the decoder(s) 1360 of FIG. 13C omits the encoder-decoder self-attention layer (since there is no encoder in this implementation). As such, the decoder(s) 1360 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1360. As with the decoder(s) 1345 of FIG. 13B, each token (e.g., word) may flow through a separate path in the decoder(s) 1360, and the decoder(s) 1360, a classifier 1365, and a generation mechanism 1370 may use auto-regression to sequentially generate one token at a time until predicting a symbol or token that represents the end of the response. The classifier 1365 and the generation mechanism 1370 may operate similarly as the classifier 1350 and the generation mechanism 1355 of FIG. 13B, with the generation mechanism 1370 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). As such, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that allow the computing device 1400 to communicate with other computing devices via an electronic communication network, included wired and/or wireless communications. The communication interface 1410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may allow the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that allow detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to allow the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Data Center

FIG. 15 illustrates an example data center 1500 that may be used in at least one embodiments of the present disclosure. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (“node C.R.s”) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1528, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter “Spark”) that may use distributed file system 1538 for large-scale data processing (e.g., “big data”). In at least one embodiment, job scheduler 1528 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1528. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: obtaining, from one or more client devices, input data corresponding to a narrative; determining, based at least on one or more first language models processing the input data, a series of scenes corresponding to respective portions of the input data; generating, based at least on one or more second language models processing the respective portions of the input data, text data representing scene information corresponding to one or more scenes of the series of scenes; generating, based at least on the scene information, image data representing one or more images depicting one or more visual representations corresponding to the one or more scenes; generating one or more storyboard frames corresponding to the one or more scenes, the one or more storyboard frames including at least the scene information and the one or more images; and sending, to the one or more client devices, data representing one or more storyboards that include the one or more storyboard frames.
B. The method of paragraph A, further comprising: generating, based at least on one or more differences between a sequential pair of storyboard frames, one or more intermediate storyboard frames; and generating one or more animatics including at least the one or more intermediate storyboard frames between the sequential pair of storyboard frames.
C. The method of any one of paragraphs A-B, further comprising: generating, for the one or more scenes and based at least on processing at least one or more portions of the text data that are representative of one or more scene descriptions for the one or more scenes, second text data representative of cinematographic information for the one or more scenes, wherein the one or more storyboard frames further include the cinematographic information for the one or more scenes.
D. The method of paragraph C, wherein the generating of the image data representing the one or more images depicting the one or more visual representations corresponding to the one or more scenes is further based at least on the cinematographic information for the one or more scenes.
E. The method of any one of paragraphs A-D, wherein the scene information includes one or more scene descriptions associated with the one or more scenes, the one or more scene descriptions including at least one of: action information associated with the one or more scenes; setting information associated with the one or more scenes; contextual information associated with the one or more scenes; tone information associated with the one or more scenes; or audio information associated with the one or more scenes.
F. The method of any one of paragraphs A-E, wherein the scene information includes one or more cinematographic details associated with the one or more scenes, the one or more cinematographic details including at least one of: camera shot information associated with the one or more scenes; camera angle information associated with the one or more scenes; or camera movement information associated with the one or more scenes.
G. The method of any one of paragraphs A-F, further comprising: applying, as input to one or more machine learning models, at least a portion of the text data representative of the scene information, wherein the generating of the image data representing the one or more images depicting the one or more visual representations corresponding to the one or more scenes is further based at least on the one or more machine learning models processing at least the portion of the text data.
H. A system comprising: one or more processors to: segment, using one or more language models, text data representing a narrative into a plurality of scenes corresponding to respective portions of the text data; generate, using one or more machine learning models and based at least on the respective portions of the text data, data representing one or more storyboard frames corresponding to one or more scenes of the plurality of scenes; and send, to one or more client devices, the data representing the one or more storyboard frames.
I. The system of paragraph H, wherein the segmentation of the text data into the plurality of scenes using the one or more language models comprises, at least: preprocessing the text data to at least one of normalize or tokenize the text data; processing, using one or more Bidirectional Encoder Representations from Transformers (BERT) models, the text data or a preprocessed version of the text data to generate a plurality of sentence embeddings; computing one or more scores indicative of degree of similarity between one or more first sentence embeddings and one or more second sentence embeddings of the plurality of sentence embeddings; and associating, based at least on the one or more scores, one or more subsets of the plurality of sentences with the one or more scenes.
J. The system of any one of paragraphs H-I, the one or more processors further to: determine, using one or more second language models and based at least on the respective portions of the text data, one or more features corresponding to the one or more scenes, wherein the generation of the one or more storyboard frames using the one or more machine learning models is further based at least on the one or more features.
K. The system of any one of paragraphs H-J, the one or more processors further to: compute, for at least the one or more scenes, one or more scores indicative of one or more rankings of the one or more scenes based at least on one or more contributions of the one or more scenes to a plot associated with the narrative, wherein the generation of the one or more storyboard frames corresponding to the one or more scenes is further based at least on the one or more scores for the one or more scenes meeting or exceeding a threshold.
L. The system of any one of paragraphs H-K, the one or more processors further to: generate, using one or more second language models and based at least on the respective portions of the text data, second text data representing scene descriptions corresponding to the one or more scenes, wherein the generation of the one or more storyboard frames using the one or more machine learning models is further based at least on the second text data.
M. The system of any one of paragraphs H-L, the one or more processors further to: generate, using one or more second machine learning models and based at least on the respective portions of the text data, second text data representing cinematographic information corresponding to the one or more scenes, wherein the generation of the one or more storyboard frames using the one or more machine learning models is further based at least on the second text data.
N. The system of any one of paragraphs H-M, the one or more processors further to: generate, using one or more second machine learning models and based at least on second text data representing at least one of scene descriptions or cinematographic information corresponding to the one or more scenes, one or more images depicting one or more visual representations corresponding to the one or more scenes, wherein the generation of the one or more storyboard frames is further based at least on the one or more images.
O. The system of any one of paragraphs H-N, the one or more processors further to: generate, based at least on a sequential pair of storyboard frames, one or more intermediate storyboard frames representative of a transition between the sequential pair of storyboard frames; generate one or more animatics including at least the sequential pair of storyboard frames and the one or more intermediate storyboard frames; and send, to the one or more client devices, the one or more animatics.
P. The system of any one of paragraphs H-O, the one or more processors further to: generate, using the one or more machine learning models and based at least on the respective portions of the text data, one or more second storyboard frames corresponding to one or more updated versions of the one or more scenes; and obtain, from the one or more client devices, input data indicating a selection of the one or more storyboard frames over the one or more second storyboard frames, wherein the sending of the one or more storyboard frames to the one or more client devices is based at least on the selection.
Q. The system of any one of paragraphs H-P, wherein the system is comprised in at least one of: a control system for an autonomous or semi-autonomous machine; a system for generating synthetic data; or a system implemented using cloud computing resources.
R. The system of any one of paragraphs H-Q, the one or more processors further to: obtain, from the one or more client devices, input data indicating a request to update at least one of one or more scene descriptions, one or more cinematographic details, or one or more visual representations associated with the one or more storyboard frames; and generate, using the one or more machine learning models and based at least on one or more parameters included in the input data, one or more updated versions of the one or more storyboard frames.
S. One or more processors comprising: processing circuitry to cause presentation, on one or more displays of one or more client devices, of one or more animatics generated using data representing a storyboard corresponding to a narrative, wherein the data representing the storyboard is generated, at least, by: segmenting, using one or more language models, text data representing the narrative into one or more scenes corresponding to one or more portions of the text data; and generating, using one or more machine learning models and based at least on the segmenting, one or more frames of the storyboard corresponding to the one or more scenes, the one or more frames including, at least: scene description data indicative of one or more scene descriptions associated with the one or more scenes; cinematographic data indicative of one or more cinematographic details associated with the one or more scenes; and image data representing one or more images depicting one or more visual representations associated with the one or more scenes.
T. The one or more processors of paragraph S, wherein the one or more processors are comprised in at least one of: a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

What is claimed is:

1. A method comprising:
obtaining, from one or more client devices, input data corresponding to a narrative;
determining, based at least on one or more first language models processing the input data, a series of scenes corresponding to respective portions of the input data;
generating, based at least on one or more second language models processing the respective portions of the input data, text data representing scene information corresponding to one or more scenes of the series of scenes;
generating, based at least on the scene information, image data representing one or more images depicting one or more visual representations corresponding to the one or more scenes;
generating one or more storyboard frames corresponding to the one or more scenes, the one or more storyboard frames including at least the scene information and the one or more images; and
sending, to the one or more client devices, data representing one or more storyboards that include the one or more storyboard frames.

2. The method of claim 1, further comprising:
generating, based at least on one or more differences between a sequential pair of storyboard frames, one or more intermediate storyboard frames; and
generating one or more animatics including at least the one or more intermediate storyboard frames between the sequential pair of storyboard frames.

3. The method of claim 1, further comprising:
generating, for the one or more scenes and based at least on processing at least one or more portions of the text data that are representative of one or more scene descriptions for the one or more scenes, second text data representative of cinematographic information for the one or more scenes,
wherein the one or more storyboard frames further include the cinematographic information for the one or more scenes.

4. The method of claim 3, wherein the generating of the image data representing the one or more images depicting the one or more visual representations corresponding to the one or more scenes is further based at least on the cinematographic information for the one or more scenes.

5. The method of claim 1, wherein the scene information includes one or more scene descriptions associated with the one or more scenes, the one or more scene descriptions including at least one of:
action information associated with the one or more scenes;
setting information associated with the one or more scenes;
contextual information associated with the one or more scenes;
tone information associated with the one or more scenes; or
audio information associated with the one or more scenes.

6. The method of claim 1, wherein the scene information includes one or more cinematographic details associated with the one or more scenes, the one or more cinematographic details including at least one of:
camera shot information associated with the one or more scenes;
camera angle information associated with the one or more scenes; or
camera movement information associated with the one or more scenes.

7. The method of claim 1, further comprising:
applying, as input to one or more machine learning models, at least a portion of the text data representative of the scene information,
wherein the generating of the image data representing the one or more images depicting the one or more visual representations corresponding to the one or more scenes is further based at least on the one or more machine learning models processing at least the portion of the text data.

8. A system comprising:
one or more processors to:
segment, using one or more language models, text data representing a narrative into a plurality of scenes corresponding to respective portions of the text data;
generate, using one or more machine learning models and based at least on the respective portions of the text data, data representing one or more storyboard frames corresponding to one or more scenes of the plurality of scenes; and
send, to one or more client devices, the data representing the one or more storyboard frames.

9. The system of claim 8, wherein the segmentation of the text data into the plurality of scenes using the one or more language models comprises, at least:
preprocessing the text data to at least one of normalize or tokenize the text data;
processing, using one or more Bidirectional Encoder Representations from Transformers (BERT) models, the text data or a preprocessed version of the text data to generate a plurality of sentence embeddings;
computing one or more scores indicative of degree of similarity between one or more first sentence embeddings and one or more second sentence embeddings of the plurality of sentence embeddings; and
associating, based at least on the one or more scores, one or more subsets of the plurality of sentences with the one or more scenes.

10. The system of claim 8, the one or more processors further to:
determine, using one or more second language models and based at least on the respective portions of the text data, one or more features corresponding to the one or more scenes,
wherein the generation of the one or more storyboard frames using the one or more machine learning models is further based at least on the one or more features.

11. The system of claim 8, the one or more processors further to:
compute, for at least the one or more scenes, one or more scores indicative of one or more rankings of the one or more scenes based at least on one or more contributions of the one or more scenes to a plot associated with the narrative,
wherein the generation of the one or more storyboard frames corresponding to the one or more scenes is further based at least on the one or more scores for the one or more scenes meeting or exceeding a threshold.

12. The system of claim 8, the one or more processors further to:
generate, using one or more second language models and based at least on the respective portions of the text data, second text data representing scene descriptions corresponding to the one or more scenes,
wherein the generation of the one or more storyboard frames using the one or more machine learning models is further based at least on the second text data.

13. The system of claim 8, the one or more processors further to:
generate, using one or more second machine learning models and based at least on the respective portions of the text data, second text data representing cinematographic information corresponding to the one or more scenes,
wherein the generation of the one or more storyboard frames using the one or more machine learning models is further based at least on the second text data.

14. The system of claim 8, the one or more processors further to:
generate, using one or more second machine learning models and based at least on second text data representing at least one of scene descriptions or cinematographic information corresponding to the one or more scenes, one or more images depicting one or more visual representations corresponding to the one or more scenes,
wherein the generation of the one or more storyboard frames is further based at least on the one or more images.

15. The system of claim 8, the one or more processors further to:
generate, based at least on a sequential pair of storyboard frames, one or more intermediate storyboard frames representative of a transition between the sequential pair of storyboard frames;
generate one or more animatics including at least the sequential pair of storyboard frames and the one or more intermediate storyboard frames; and
send, to the one or more client devices, the one or more animatics.

16. The system of claim 8, the one or more processors further to:
generate, using the one or more machine learning models and based at least on the respective portions of the text data, one or more second storyboard frames corresponding to one or more updated versions of the one or more scenes; and
obtain, from the one or more client devices, input data indicating a selection of the one or more storyboard frames over the one or more second storyboard frames,
wherein the sending of the one or more storyboard frames to the one or more client devices is based at least on the selection.

17. The system of claim 8, the one or more processors further to:
obtain, from the one or more client devices, input data indicating a request to update at least one of one or more scene descriptions, one or more cinematographic details, or one or more visual representations associated with the one or more storyboard frames; and
generate, using the one or more machine learning models and based at least on one or more parameters included in the input data, one or more updated versions of the one or more storyboard frames.

18. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

19. One or more processors comprising:
processing circuitry to cause presentation, on one or more displays of one or more client devices, of one or more animatics generated using data representing a storyboard corresponding to a narrative, wherein the data representing the storyboard is generated, at least, by:
segmenting, using one or more language models, text data representing the narrative into one or more scenes corresponding to one or more portions of the text data; and
generating, using one or more machine learning models and based at least on the segmenting, one or more frames of the storyboard corresponding to the one or more scenes, the one or more frames including, at least:
scene description data indicative of one or more scene descriptions associated with the one or more scenes;
cinematographic data indicative of one or more cinematographic details associated with the one or more scenes; and
image data representing one or more images depicting one or more visual representations associated with the one or more scenes.

20. The one or more processors of claim 19, wherein the one or more processors are comprised in at least one of:
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
